(19) United States
(12) Patent Application Publication
(10) Pub. No.: US 2012/0255451 A1
(43) Pub. Date: Oct. 11, 2012

(54) MIXTURE OF NON-AROMATIC SOLVENTS, PREPARATION METHOD THEREOF AND USE OF SAME FOR PRINTING INKS AND VARNISHES

(75) Inventors: Joan Pineda Domingo, Sant Celoni (ES); Cesar Quera Perez, Barcelona (ES); Antoine Westelynck, Brueil en Vexin (FR)

(73) Assignee: Total Raffinage Marketing, Puteaux (FR)

(21) Appl. No.: 13/516,382

(22) PCT Filed: Dec. 15, 2010
(86) PCT No.: PCT/IB10/55832

§ 371 Date: Jun. 15, 2012

(30) Foreign Application Priority Data
Dec. 15, 2009 (FR) 0959019

(51) Int. Cl. C08K 5/09; C09D 11/02

(52) U.S. Cl. 101/130; 106/505; 106/31.86

(57) ABSTRACT

The present disclosure relates to mixtures of non-aromatic solvents which can be used for the manufacture of varnishes and printing inks in particular for planographic printing (or offset printing). These mixtures of solvents include from 80 to 99.5% by mass of a slightly aromatic hydrocarbon oil and from 0.5 to 20% by mass of a composition composed predominantly of saturated and/or unsaturated C16 to C22 monocarboxylic fatty acids, optionally in a mixture with resin acids (unsaturated polycyclic—in particular tricyclic—monocarboxylic acids).

### CROSS-REFERENCE TO RELATED APPLICATIONS

This application is a National Phase Entry of International Application No. PCT/IB2010/055832, filed on Dec. 15, 2010, which claims priority to French Patent Application Serial No. 09 59019, filed on Dec. 15, 2009, both of which are incorporated by reference herein.

### FIELD OF THE INVENTION

The present invention relates to the use of fatty acids as substitutes for aromatic compounds in solvents for vehicles or varnishes and printing inks. Moreover, the invention relates to printing inks which contain binders, pigments, solvents without aromatics, as well as additives if appropriate.

### BACKGROUND

In order to produce the widest range of printed products, three main types of printing are conventionally used: relief printing, planographic printing (or offset printing or lithography) as well as photogravure printing, as well as digital systems which do not form part of the present invention. In relief printing, the printing ink is transferred to the substrate from hard relief letters which are coated with a thin layer of viscous ink. The printing ink must be such that it dries relatively slowly and does not start to set too soon.

In offset printing, the shape to be represented is fixed on printing plates with separation of areas having opposite polarity. The hydrophobic viscous printing ink wets only the areas of the printing plates which are equally hydrophobic. Depending on the type of drying it is possible to draw a distinction between: so-called heat-set inks for web-fed rotary presses which dry by application of heat, inks for so-called sheet-fed machines drying by absorption and oxidation, and also cold-set inks (newspaper inks) which dry by absorption into the porous substrate.

In the photogravure printing process, the design is etched onto the printing plate. After wetting the printing plate with the relatively fluid printing ink, the surface is scraped, and the printing ink remains only in the etched recesses, from which it is then transferred onto the substrate to be printed.

Printing inks have to satisfy a large number of economic and also environmental requirements. The main constituents of a printing ink are the pigments, binders, solvents and additives with which the desired properties of the inks and of the resulting print are modified. The various requirements with which the physical properties must comply while taking account of economic criteria, in particular in the case of mass printing products, impose severe constraints on the solvents used in the printing ink. On the one hand, the solvent must be capable of dissolving binders as well as various additives, and on the other hand it must make it possible to achieve viscosity and tack within the desired range. Because of their favourable price, mineral oils (of petroleum origin) have become established as solvents in the field of printing inks.

Unlike hydrocarbon fuels, the mineral oils commonly used as solvents have a narrow distillation range between the initial boiling point (IBP) and the final boiling point (FBP). The initial boiling point and the final boiling point of hydrocarbon fluids, defined by the standards ASTM D-86 or ASTM D-1160, are chosen according to the envisaged uses, the advantage of a tight distillation range being that of having a very precise flashpoint, which proves useful for safety reasons. Another advantage is the precise control of the drying and evaporation performances of the solvents in the offset printing inks.

The most widely used hydrocarbon solvents (or mineral oils) are hydrocarbon solvents which contain aromatic compounds in variable proportions (up to a few tens of % by mass) as they have an excellent solubilization capability or solvent power with respect to resins or binders for printing inks. However, these aromatic solvents are not the most satisfactory from the point of view of toxicity, the protection and safety of the environment, in particular with respect to living organisms. Analyses of commercial aromatic mineral oils currently used as solvents for inks show that they have an aromatics content measured according to the standard IP 391 ranging from 13 to 33% by weight and a polycyclic aromatic hydrocarbons (PAHs) content measured by mass spectrometry ranging from 240,000 to 700,000 ng/g (see Table 1). It is admitted that PAHs are particularly harmful to the environment and living organisms, resulting in a tightening of the regulations already in place and to be introduced in numerous countries. Moreover, for the offset printing of food packaging, the European regulations of which are currently under discussion on the basis of the texts in force in Switzerland, the use of dearomatized hydrocarbon solvents is more than desirable given that the requirements of certain ink manufacturers include approval for incidental contact with food.

The inks and varnishes industry is therefore increasingly demanding technical solutions utilizing PAH contents which are as low as possible: there is a need for solvents for vehicles or varnishes and printing inks which do not have such drawbacks for the environment and living organisms and which are economically acceptable. These aromatic mineral oils can be replaced by other mineral oils containing few, or even no aromatic compounds: such as for example naphthenic mineral oils, rich in naphthenic compounds considered to be more environmentally friendly than aromatic compounds. However, it is found that non-aromatic, for example naphthenic, mineral oils have a significantly lower solvent power than aromatic mineral oils with respect to binder resins (Ullmann's Encyclopedia of Industrial Chemistry, A 22, 147 (1993)). Moreover, their use is sometimes limited, in particular with most of the resins with a high molecular weight (for example phenolic modified rosin resins with low solubility).

Other alternative solutions have also been proposed:

EP 255,871 proposes a hydrocarbon solvent with high solvent power having a boiling point comprised between 160 and 300° C. which comprises 1 to 15% of alkyl tetralins, up to 10% of aromatic compounds and is substantially devoid of naphthalenes and biphenyls. Such a solvent is particularly expensive and unsuitable for numerous printing ink applications.

U.S. Pat. No. 7,056,869 describes a composition comprising a hydrocarbon fluid having a boiling point within the range from 235 to 400° C. comprising at least 60% of naphthenic compounds and at least 20% of polynaphthenic compounds and a silicone oil. This liquid composition can advantageously be used in particular as a solvent for printing inks given its very good solvent power but again, this solution proves too expensive and, furthermore, the naphthenic compounds used at such levels have a tendency to degrade the stability of the inks and alter the printing parameters, in particular the tack (measured using a Tack-o-Scope instrument).

EP 697,446 relates to printing ink vehicles with high solvent power comprising specific phenolic resins derived from (di)cyclopendadiene, alpha-olefin and unsaturated carboxylic acid or anhydride combined with a siccative or semi-siccative oil (linseed, tung and/or soya oil etc.) and a non-aromatic hydrocarbon solvent containing preferably at least 60% of naphthenic compounds and with a boiling point above 200° C.

EP 823,930 describes mixtures comprising from 80 to 99% by weight of a mineral oil without aromatic compounds and from 1 to 20% by weight of fatty acid esters of C8 to C22 fatty acids which can be used as printing ink solvents. This technical solution makes it possible to improve the solvent power of the dearomatized mineral oil but has the drawback of requiring a high level of esters in particular with resins having a high molecular weight (see Table 2).

U.S. Pat. No. 6,224,661 describes mixtures of mineral oils and fatty acids for digital printing inks (inkjet type) specifically suitable for porous supports. Typically, the compositions of these inks are as follows: at least 10% by mass of pigments, from 30 to 70% of fatty acids, from 5 to 30% of waxes, from 1 to 15% of a resin and less than 10% of a dispersant, with a viscosity preferably comprised between 8 and 12 cPs at 80° C. It is clear to a person skilled in the art of inks that these compositions with a very low viscosity relate exclusively to inks for inkjet printing, not covered by the present invention.

The purpose of the invention is to completely or at least partially replace the aromatic constituents in the solvent mixtures used for the production of vehicles or varnishes and printing inks with solvents which are at least just as efficient but clearly superior from the point of view of compatibility with the environment whilst remaining economically acceptable for printing ink applications. Surprisingly, it has now been found that the aromatic constituents in solvents for vehicles or varnishes and printing inks in the most widely differing fields of use can be partially or completely replaced by compositions based on fatty acids.

### DETAILED DESCRIPTION

The invention relates to a mixture of solvents which can be used to manufacture vehicles or varnishes and printing inks, characterized in that the mixture of solvents contains:

a) from 80 to 99.5%, preferably from 90 to 98%, by mass of a slightly aromatic, preferably non-aromatic hydrocarbon oil (aromatics content measured according to IP 391 less than 1% by mass, preferably less than 0.1% by mass), and

b) from 0.5 to 20%, preferably from 2 to 10%, by mass of a composition composed predominantly of saturated and/or unsaturated C16 to C22 monocarboxylic fatty acids, optionally in a mixture with resin acids (unsaturated polycyclic—in particular tricyclic—monocarboxylic acids).

Within the meaning of the present invention, by composition composed predominantly of C16 to C22 monocarboxylic fatty acid(s), is meant any composition the C16 to C22 monocarboxylic fatty acid(s) concentration of which represents from 80% to 100% of the total mass of the composition. In general, the remainder of the composition comprises monocarboxylic fatty acids the hydrocarbon chain of which has less than 16 carbon atoms and/or more than 22 carbon atoms. The compositions constituted predominantly of C16 to C22 monocarboxylic fatty acid(s) optionally include resin acids. The concentration of resin acids preferably represents up to 10% by mass of the acids (fatty acids+resin acids) of resin acid(s) and advantageously less than 5% of the total mass of the acids (fatty acids+resin acids).

The compositions composed predominantly of C16 to C22 monocarboxylic fatty acids(s) can be obtained for example by hydrolysis of natural and/or genetically modified vegetable oils, of animal fats; there may be mentioned the fatty acids derived from peanut, palm, olive, rapeseed, cotton, grapeseed, corn, sunflower, soya, linseed oils, tallow and/or derived from lard. Among the resin acids, there may be mentioned the abietic, dihydroabietic, tetrahydroabietic, dehydroabietic, neoabietic, pimaric, levopimaric, palustric acids.

The compositions composed predominantly of fatty acids and containing resin acids can be obtained by distillation of tall oil, by-product of the manufacture of wood pulp; the term TOFAs is then used, an acronym of tall oil fatty acids. TOFAs are for example marketed by the companies TOTAL ADDITIFS & CARBURANTS SPECIAUX under the trade names PC 30, PC 31 and PC 32, Arizona Chemical under the trade name Sylfat (for example Sylfat 2) or Eastman Chemical under the trade name Pamolyn (for example Pamolyn 200). In these commercial products, the resin acids represent less than 10% by mass and advantageously less than 5% of the total mass of the acids (fatty acids+resin acids). The preferred compositions based on fatty acids are of natural origin, i.e. within the meaning of the present invention of vegetable and/or animal origin and not of fossil origin.

The weakly or even non-aromatic hydrocarbon oils are in general obtained from cuts of petroleum products originating from refineries and the processes for obtaining them generally implement refining processes such as fractionation and purification which make it possible to reduce the level of aromatics. Purification typically consists of hydrodesulphurization and/or hydrogenation in order to reduce and in certain cases remove the sulphur content, in certain cases, in order to remove the sulphur present and hydrogenation in order to reduce or remove the aromatic compounds (dearomatized oils) and the unsaturated compounds. In a standard fashion, the aliphatic hydrocarbon mineral oils are obtained from virgin petroleum cuts or from cuts resulting from reforming and distillation processes, which have been previously hydrodesulphurized and fractionated. The dearomatized mineral oils are obtained from hydrodesulphurized, fractionated and hydrogenated products in order to saturate the aromatics present; the hydrogenation can take place before the final fractionation. The weakly or even non-aromatic hydrocarbon oils can be of mineral origin (petroleum oils, but also originating from coal (Coal to Liquid), gas (Gas to Liquid)) and/or from renewable, animal and/or vegetable sources such as originating from biomass (BtL), for example from the hydrotreatment and isomerization of vegetable oil esters.

The hydrocarbon oils according to the invention generally have boiling temperatures ranging from 220 to 350° C.; oils originating from cuts having narrower boiling ranges generally being preferred. The preferred hydrocarbon oils have boiling ranges from 230° C. to 270° C., from 255° C. to 295° C., from 280° C. to 320° C. and from 300° C. to 350° C.

The mixtures of solvents according to the invention are preferably liquids at ambient temperature. A subject of the present invention is also a method for preparing the mixtures of solvents described previously. This method consists of mixing at ambient temperature the mineral oil which is only slightly aromatic or non-aromatic and the composition composed predominantly of saturated and/or unsaturated C16 to C22 fatty acids optionally in a mixture with resin acids. In a preferred embodiment of the invention, the components of the solvent mixture are chosen so that the solvent mixture is liquid at ambient temperature, generally between 10 and 30° C.

The invention also relates to vehicles or varnishes for printing inks which comprise one or more binders, a mixture of solvents as defined previously and if appropriate containing other constituents such as surfactants, fillers, stabilizers, siccative or semi-siccative oils, rheology-improving agents, anti-oxidant additives, drying accelerators, anti-abrasion agents, gelling agents, etc. As examples of siccative or semi-siccative oils, there may be mentioned linseed, tung and safflower oils.

The role of binders is on the one hand to transport or convey pigments or colorants and on the other hand to promote the adhesion of the ink to the substrate. Binders comprise one or more resins of natural and/or synthetic origin. The natural resins are generally organic materials of natural, vegetable and/or animal origin such as rosin, balsam oil, shellac. The synthetic resins include synthetic polymers and modified natural resins.

Synthetic polymers can be thermoplastic polymers and/thermosetting polymers. As examples of synthetic polymers, there may be mentioned hydrocarbon resins, polyvinyl halides, styrene and maleic anhydride copolymers, polyamides, products originating from the condensation of ketone and aldehyde, acrylic resins, epoxide resins, phenolic resins, polyolefins, polyester resins, polyurethane resins, products originating from the condensation of urea and melamine-formaldehyde, terpene resins, alkyd resins and mixtures thereof. As examples of modified natural resins, there may be mentioned the alkyd resins modified by fatty acids of natural origin, cellulosic resins, rosin esters, rosin-modified phenolic resins, rosin-modified maleic or fumaric resins, rosin dimers and polymers and mixtures thereof.

Generally, varnishes or vehicles for printing inks comprise:
from 20 to 60% by weight of binder(s),
from 10 to 50% of solvent(s)
from 0 to 20% of semi-siccative oils or drying oils optionally one or more constituents such as anti-corrosion, anti-abrasion additives, drying accelerators, gelling agents, surfactants, fillers, rheology-improving agents etc. Each of these additives is generally in a quantity less than or equal to 5% of the total mass of the printing ink.

The invention also relates to printing inks, in particular inks for planographic printing (or also offset printing) which are divided into three types: heat-set inks, inks for so-called sheet-fed machines, cold-set inks (newspaper inks). Advantageously, the printing inks according to the invention comprise a vehicle or varnish as defined previously and from 10 to 25% by mass of pigment(s). The printing inks according to the invention can advantageously be used for applications leading to incidental contact with food, to the extent that the constituents of the vehicle, and in particular of the mixture of solvents according to the invention and of the pigments/colorants are suitable for incidental contact with food (FDA approval for example). These inks are generally manufactured from a vehicle or varnish as defined previously to which one or more pigments, one or more solvents, siccative or semi-siccative oils are added as well as optionally various previously mentioned additives improving the performances of the ink. These mixing operations are advantageously carried out at temperatures ranging from 15 to 100° C.

Unless otherwise indicated, the quantities and the percentages given in the examples below are mass values.

### Example 1

Table 1 below summarizes the physical and chemical characteristics of 8 mineral oils marketed in Europe as solvents for printing inks:

The following are measured for each of the mineral oils:
density measured according to the standard EN ISO 12185
viscosity at 20° C. measured according to the standard EN ISO 3104
refractive index measured according to the standard ASTM.D 1214
aromatics content measured according to the standard IP391
DMSO extract measured according to the standard IP346
initial IP and final FP distillation points measured according to the standard ASTM.D 2887
PAH (polycyclic hydrocarbons) content measured by mass spectrometry

TABLE 1

| | HM1 | HM2 | S1 | S2 | S3 | S4 | S5 | HM3 |
|---|---|---|---|---|---|---|---|---|
| Properties of | | | | | | | | |
| commercial mineral oils | | | | | | | | |
| Density at 15° C. (kg/m3) | 837.5 | 830.2 | 836.2 | 839.6 | 851.2 | 831.2 | 832.0 | 813.0 |
| Viscosity a 20° C. (mm²/s) | 5.25 | 5.47 | 5.29 | 8.1 | 5.38 | 5.36 | 7.56 | 4.83 |
| Refractive index at 20° C. | 1.4633 | 1.4608 | 1.4629 | 1.4637 | 1.4744 | 1.4619 | 1.4625 | 1.4484 |
| Aromatics content (%) | 18 | 18.69 | 17.78 | 13.23 | 32.7 | 23.16 | 18.57 | 0.003 |
| DMSO extract (%) | 2.0 | 0.2 | 1.7 | 0.3 | 2.8 | 2.0 | 0.6 | 0.1 |
| Simulated Distillation | | | | | | | | |
| Initial Point (° C.) IP | 251.3 | 262.4 | 255.1 | 274.3 | 262.2 | 264.7 | 280.5 | 252.7 |
| Final Point (° C.) FP | 300.4 | 295.7 | 299.5 | 319.0 | 293.5 | 294.6 | 312.6 | 285.9 |
| PAH (ng/g) | | | | | | | | |
| Naphthalene | 16042 | 1336 | 6154 | 10650 | 14870 | 6291 | 457 | 12 |
| Acenaphthylene | \| | \| | \| | \| | \| | \| | \| | 22 |
| Acephatene | \| | \| | \| | \| | \| | \| | \| | 170 |
| Fluorene | \| | \| | \| | \| | \| | \| | \| | 144 |
| Phenanthrene | 225255 | 336666 | 238140 | 390211 | 484219 | 336498 | 679998 | 204 |
| Anthracene | 3335 | 9686 | 4100 | 3954 | 13164 | 7886 | 12339 | 19 |
| Fluoranthene | 50 | 17 | 33 | 1439 | 55 | 89 | 356 | 26 |
| Pyrene | 61 | 93 | 49 | 563 | 78 | 263 | 226 | 46 |
| Benzo(a)anthracene | <1 | <1 | <1 | 2 | 2 | <1 | <1 | <1 |
| (CAS No. 56-55-3) | | | | | | | | |
| Triphenylene + Chrysene | <5 | <5 | <5 | <5 | 7 | <5 | <5 | <5 |
| (CAS No. 218-01-9) | | | | | | | | |
| Benzo(b)fluoranthene | <5 | <5 | <5 | <5 | <5 | <5 | <5 | <5 |
| (CAS No. 205-99-2) + | | | | | | | | |
| Benzo(k)fluorathene | | | | | | | | |
| (CAS No. 207-08-9) + | | | | | | | | |
| Benzo(j)fluoranthene | | | | | | | | |
| (CAS No. 205-82-3) | | | | | | | | |
| Benzo(e)pyrene | <2 | <2 | <2 | <2 | <2 | <2 | <2 | <2 |
| (CAS No. 192-97-2) | | | | | | | | |
| Benzo(a)pyrene | <2 | <2 | <2 | <2 | <2 | <2 | <2 | <2 |
| (CAS No. 50-32-8) | | | | | | | | |
| Perylene | <2 | <2 | <2 | <2 | <2 | <2 | <2 | <2 |
| Indeno(1,2,3)pyrene | <3 | <3 | <3 | <3 | <3 | <3 | <3 | <3 |
| Dibenzo(a,h)anthracene | 0.5 | <0.5 | <0.5 | <0.5 | <0.5 | <0.5 | <0.5 | <0.5 |
| (CAS No. 53-70-3) + | | | | | | | | |
| Dibenzo(a.c) anthracene | | | | | | | | |
| Benzo(ghi)perylene | <3 | <3 | <3 | <3 | <3 | <3 | <3 | <3 |
| Σ of the PAHs | 244743 | 347798 | 248476 | 406819 | 512395 | 351027 | 693376 | 643 |

### Example 2

Various mixtures of a mineral oil and a co-solvent are prepared at ambient temperature.

The co-solvents are commercial tall oil fatty acids containing less than 10% of resin acids, denoted TOFA 1 to 3, marketed by TOTAL ACS (TOFA 1 and 2) and by Eastman (TOFA 3) respectively, isopropyl laurate, mixtures of rapeseed fatty acids marketed by Oleon, grapeseed oil fatty acids marketed by Uniqema, coconut fatty acids marketed by Oleon, soya fatty acids marketed by Uniqema and Oleon.

The following are measured
the aniline point (measured according to the standard ASTM D 611)
the cloud point of a composition comprising 90% of said mixture and 10% of a phenolic modified rosin resin, marketed by the company Cray Valley under the name Tergraf UZ 86 measured using a Chemotronic device
the mineral oil tolerance of a composition which corresponds to the volume of said mixture which, added to 5 g of Synolac 6622 isophthalic alkyd resin, produces a cloudy mixture at 23° C. (by visual assessment)

The results are summarized in Table 2.

By way of comparison, the same properties are measured for 3 commercial mineral oils of Table 1, HM1 & HM2 containing approximately 18% of aromatic compounds and HM3, a dearomatized mineral oil as well as for the HM4 mixture (a mixture of HM3 dearomatized mineral oil and isopropyl laurate-type fatty acid ester as described in EP 823.930)

The HM5 to HM16 mixtures correspond to mixtures according to the present invention. With respect to HM3, it is found that these mixtures have much better solvent power, although not always achieving the performances of the HM1 or HM2 aromatic mineral oils of the prior art. For compositions according to the invention containing 6 or 10% of co-solvent, (HM7, HM8 and HM16 mixtures), the solvent power is significantly equal to or greater than the power of the HM1 or HM2 aromatic mineral oils.

TABLE 2

| Composition of | | | | | | | | | | | | | | | |
|---|---|---|---|---|---|---|---|---|---|---|---|---|---|---|---|
| the mixture | | | | | | | | | | | | | | | |
| (HMx) (%) | HM1 | HM2 | HM3 | HM4 | HM5 | HM7 | HM8 | HM9 | HM10 | HM11 | HM12 | HM13 | HM14 | HM15 | HM16 |
| HM1 | 100 | | | | | | | | | | | | | | |
| HM2 | | 100 | | | | | | | | | | | | | |
| HM3 | | | 100 | 90 | 96 | 94 | 90 | 96 | 96 | 96.4 | 96.5 | 96.6 | 96 | 96 | 90 |
| Isopropyl | | | | 10 | | | | | | | | | | | |
| laurate | | | | | | | | | | | | | | | |
| TOFA 1 | | | | | 4 | 6 | 10 | | | | | | | | |
| TOFA2 | | | | | | | | 4 | | | | | | | |
| TOFA3 | | | | | | | | | 4 | | | | | | |
| Mixture of | | | | | | | | | | 3.6 | | | | | |
| rapeseed fatty | | | | | | | | | | | | | | | |
| acids | | | | | | | | | | | | | | | |
| Mixture of | | | | | | | | | | | 3.5 | | | | |
| grapeseed | | | | | | | | | | | | | | | |
| fatty acids | | | | | | | | | | | | | | | |
| Mixture of | | | | | | | | | | | | 3.4 | | | |
| coconut fatty | | | | | | | | | | | | | | | |
| acids | | | | | | | | | | | | | | | |
| Mixture of | | | | | | | | | | | | | 4 | 4 | 10 |
| soya fatty | | | | | | | | | | | | | | | |
| acids | | | | | | | | | | | | | | | |
| Σ | 100 | 100 | 100 | 100 | 100 | 100 | 100 | 100 | 100 | 100 | 100 | 100 | 100 | 100 | 100 |
| Aniline point | 75 | 77.5 | 87.5 | 78 | 82 | 79.5 | 75.5 | 82.5 | 82 | 82 | 82 | 82.5 | 81.5 | 81.5 | 76 |
| (° C.) | | | | | | | | | | | | | | | |
| Cloud point (° C.) | 72 | 90 | 135 | 96 | 78 | 66 | 47 | 78 | 78 | 79 | 79 | 79 | 77 | 77 | 46 |
| Mineral oil | 45 | 41 | 25 | 40.5 | 40.5 | 50 | 66 | 40 | 40 | 40 | 39.5 | 39.5 | 40.5 | 40.5 | 71 |
| tolerance | | | | | | | | | | | | | | | |

### Example 3

VGx gelled varnishes are prepared from the compounds which are conventionally mixed in the field of varnishes for inks (resins, hydrocarbon solvents, co-solvents, HMx solvent compositions, gelling agents)

For each of these VGx gelled varnishes, the following are measured:
Duke viscosity (temperature 25° C. and pressure 2.500 s⁻¹)
cloud point of a composition comprising 30% of said varnish and 70% of a Halternan TO 6/9 Afnew aromatic hydrocarbon solvent
40° Tan Delta (1 Hz, 100 Pa)
flowability
ability to form an aqueous emulsion
tack after 1 or 10 min (0.4 mL; 40° C.; 150 m/min) as well as maximum tack and time required to obtain it.

The results are summarized in Table 3.

It is noted that the cloud point of the VG3 varnish (comparative) demonstrates the weak solvent power of the dearomatized mineral oil used alone as well as instability of the Tack measurement. It is noted that the VG5b varnish (which contains HM5 oil) according to the invention displays a particularly satisfactory compromise in terms of performance, similar to that of varnishes containing aromatic solvents.

TABLE 3

| Gelled Varnish Composition | | | | | | | | | | | |
|---|---|---|---|---|---|---|---|---|---|---|---|
| (VGx) | VG1 | VG2 | VG3 | VG4 | VG5 | VG 5a | VG5b | VG7 | VG 10 | VG 14 | VG 16 |
| Modified rosin resin | 32 | 32 | 32 | 32 | 32 | 32 | 32 | 32 | 32 | 32 | 32 |
| (Tergraf UZ-86) | | | | | | | | | | | |
| Alkyd resin | 8 | 8 | 8 | 8 | 8 | 8 | 8 | 8 | 8 | 8 | 8 |
| (Synolac 1174) | | | | | | | | | | | |
| Hydrocarbon resin | 10 | 10 | 10 | 10 | 10 | 10 | 10 | 10 | 10 | 10 | 10 |
| Soya oil | 4 | 4 | 4 | 4 | 4 | 4 | 4 | 4 | 4 | 4 | 4 |
| Mixture of co-solvents | 3 | 3 | 3 | 3 | 3 | 3 | 3 | 3 | 3 | 3 | 3 |
| Aluminium-based gelling | 0.5 | 0.5 | 0.5 | 0.5 | 0.5 | 0.8 | 0.5 | 0.5 | 0.5 | 0.5 | 0.5 |
| agent | | | | | | | | | | | |
| Optilith IV | | | | | | | 0.2 | | | | |
| HMx mineral oil mixture | 40.5 | 40.5 | 40.5 | 40.5 | 40.5 | 40.5 | 40.5 | 40.5 | 40.5 | 40.5 | 40.5 |
| HMx for adjusting viscosity | — | 2 | 3 | — | 1 | 2.7 | 1 | 1 | 1 | 1 | — |
| Σ of the components | 98 | 100 | 101 | 98 | 99 | 101 | 99.2 | 99 | 99 | 99 | 98 |
| Duke Viscosity (Pa, s) | 31 | 31 | 33 | 31 | 31 | 30 | 31 | 31 | 32 | 31 | 30 |
| Cloud point (° C.) | 97 | 101 | 106 | 101 | 95 | 94 | 96 | 92 | 95 | 95 | 83 |
| 40° Tan Delta | 2.3 | 2.1 | 2.43 | 2.14 | 2.61 | 1.39 | 2.62 | 3.34 | 2.65 | 2.91 | 3.51 |
| Flow at 20° C. (kPa, s) | 7 | 10 | 11.5 | 9 | 5.5 | 27 | 5.5 | 4.5 | 5.5 | 5 | 3.5 |
| Emulsion-forming ability | 35 | 33 | 37 | 35 | 57 | 45 | 36 | 67 | 57 | 57 | 73 |
| (water) (%) | | | | | | | | | | | |
| Tack (0.4 mL; 40° C. - 150 | 140 | 126 | 112 | 130 | 134 | 115 | 137 | 140 | | 133 | |
| m/min) after 1 min | | | | | | | | | | | |
| Tack (0.4 ml; 40° C. - 150 | 138 | 154 | 122 | 156 | 167 | 134 | 166 | 179 | | 165 | |
| m/min) after 10 min | | | | | | | | | | | |
| Tack (maximum/time in s) | 171/330 | 155/660 | 130/390 | 160/465 | 169/530 | 139/420 | 170/460 | 181/520 | | 168/510 | |

### Example 4

ERx red offset inks are prepared from VGx varnishes, HMx mineral oil and other components shown in detail in Table 4, in 2 phases: firstly the VGx, soya oil, HMx and red pigment are mixed, then GFx and HMx are added.

For each of the ink formulations obtained, the following are measured:
Duke viscosity
flowability at 20° C.
tack (0.4 mL sample at 40° C. speed 300 m/min) after 1, 2 or 3 minutes and maximum tack as a function of time
emulsion-forming ability
formation of mist (1 mL sample at 40° C.)
brightness at 60° C. (0.3 mL sample at 150° C. for 20 s)

The results are summarized in Table 4.

It is noted that the inks ER6 and ER7 exhibit an excellent compromise in all of the performances measured and in particular display improved flow properties and tack compared with ER3. They display performances comparable to those of inks formulated on the basis of aromatic oils (ER1 and ER2)

TABLE 4

| Red Ink | | | | | |
|---|---|---|---|---|---|
| Composition (ERx) | ER1 | ER2 | ER3 | ER 5b | ER7 |
| Gelled Varnishes VGx | 32 | 32 | 32 | 32 | 32 |
| Soya oil | 6 | 6 | 6 | 6 | 6 |
| Wax | 2 | 2 | 2 | 2 | 2 |
| Red Pigment | 15 | 15 | 15 | | 15 |
| Gelled Varnishes VGx | 40 | 40 | 40 | 40 | 40 |
| Mineral oil HMx | 8.5 | 11 | 9.5 | 8.6 | 8.9 |
| for adjusting the | | | | | |
| viscosity | | | | | |
| Σ of the components | 103.5 | 106 | 104.5 | 103.6 | 103.9 |
| Duke Viscosity | 12.7 | 11.5 | 13.2 | 12.8 | 13.3 |
| Flow at 20° C. | 170 | 240 | 370 | | 130 |
| Tack (after 1 min) | 135 | 98 | 102 | | 122 |
| Tack (after 2 min) | 146 | 104 | 108 | | 131 |
| Tack (after 3 min) | 159 | 110 | 114 | | 140 |
| Tack (max/time in s) | 174/290 | 150/760 | 140/500 | | 188/575 |
| Emulsion-forming | 70 | 71 | 75 | 61 | 103 |
| ability (water) | | | | | |
| Formation of mist | Ref. | Inf. | =Ref. | | Leg sup |
| Brightness at 60° C. | 58 | 57 | 53 | | 59 |

1. A mixture of solvents which can be used for producing printing inks, comprising:
a) from 80 to 99.5% by mass of a slightly aromatic or non-aromatic, hydrocarbon oil; and
b) from 0.5 to 20% by mass of a composition composed predominantly of saturated and/or unsaturated C16 to C22 fatty acids.

2. The mixture according to claim 1, comprising:
a) from 90 to 98% by mass of a slightly aromatic hydrocarbon oil; and
b) from 2 to 10% by mass of a composition predominantly composed of saturated and/or unsaturated C16 to C22 fatty acids.

3. The mixture according to claim 1, wherein the aromatics content of the hydrocarbon oil measured according to IP 391 is less than or equal to 1% by mass.

4. The mixture according to claim 1, wherein the fatty acids composition is of natural origin.

5. The mixture of solvents according to claim 1, liquid at ambient temperature.

6. A vehicle or varnish comprising one or more binders, and a mixture of solvents comprising:
a) from 80 to 99.5% by mass of a slightly aromatic or non-aromatic, hydrocarbon oil; and
b) from 0.5 to 20% by mass of a composition composed predominantly of saturated and/or unsaturated C16 to C22 fatty acids.

7. Printing ink comprising a vehicle or varnish, and one or more pigments and colorants, the vehicle or varnish comprising:
a) from 80 to 99.5% by mass of a slightly aromatic or non-aromatic, hydrocarbon oil; and
b) from 0.5 to 20% by mass of a composition composed predominantly of saturated and/or unsaturated C16 to C22 fatty acids.

8. The printing ink according to claim 7, of which most of the fatty acid composition is based on C16 to C22 fatty acids of natural origin.

9. A method for planographic printing or offset printing comprising a step of printing with an ink as defined in claim 7.

10. The mixture according to claim 1, wherein the hydrocarbon oil is non-aromatic.

11. The mixture according to claim 1, wherein the composition composed predominantly of saturated and/or unsaturated C16 to C22 fatty acids is in a mixture with resin acids.

12. The mixture according to claim 2, wherein the hydrocarbon oil is non-aromatic.

13. The mixture according to claim 2, wherein the composition composed predominantly of saturated and/or unsaturated C16 to C22 fatty acids is in a mixture with resin acids.

14. The mixture according to claim 1, wherein the aromatics content of the hydrocarbon oil measured according to IP 391 is less than or equal to 0.1% by mass.

15. The mixture according to claim 1, wherein the fatty acids composition is based on TOFA.

16. The vehicle or varnish according to claim 6, further comprising one or more constituents selected from the group of: surfactants, fillers, stabilizers, siccative or semi-siccative oils, rheology-improving agents, anti-oxidant additives, drying accelerators, anti-abrasion agents, or gelling agents.

17. The printing ink according to claim 8, of which most of the fatty acid composition is based on TOFA.

18. The method according to claim 9, wherein the planographic printing is chosen from heat-set, sheet-fed or cold-set.
